(19) United States
(12) Patent Application Publication
(10) Pub. No.: US 2015/0154526 A1
(43) Pub. Date: Jun. 4, 2015

(54) System, Method, and Device for managing and Improving Organizational and Operational Performance

(71) Applicants: Brenda L. Yates, Portland, OR (US); ROBERT FOLIE, SPOKANE, WA (US)

(72) Inventors: Brenda L. Yates, Portland, OR (US); ROBERT FOLIE, SPOKANE, WA (US)

(21) Appl. No.: 14/093,638

(22) Filed: Dec. 2, 2013

(51) Int. Cl. G06Q 10/06

(52) U.S. Cl. CPC G06Q 10/06393

(57) ABSTRACT

The present invention generally relates to systems, methods, and devices for enabling strategic execution of a plan and driving and managing end-to-end processes and activities to achieve the plan. More specifically, the present invention relates to software for driving and managing end-to-end processes including planning, goal setting, engagement, analysis, team management, project approval, implementation, and performance measurement. In one preferred embodiment, the present invention contemplates a software tool configured to enable a user to plan, implement, communicate, execute, and monitor specific activities as they relate to an overall stated goal. The tool has at least four primary components: a lead stage, an engage stage, an act stage and a perform stage. Within each stage a subroutine guides each individual user through the process necessary to achieve that particular stages end-goals based on the desired stated goal.

### BACKGROUND

The present invention generally relates to systems, methods, and devices for enabling strategic execution of a plan and driving and managing end-to-end processes and activities to achieve the plan. More specifically, the present invention relates to software for driving and managing end-to-end processes including planning, goal setting, engagement, analysis, team management, project approval, implementation, and performance measurement.

Some examples of applications include, but are not limited to, manufacturing, distribution, wholesale, retail, and service industries. Examples of channels include, but are not limited to, direct to consumer, business to business, business to consumer, and consumer to consumer. Sectors include Public and Private sector. Market segment examples include, but are not limited to, manufacturing, construction, information technology “IT”, healthcare, housing, senior care, vendor management, contracting, and consulting.

There are known approaches designed to help organizations, groups, teams and individuals manage and improve performance. Typically, organizational, team, group, and/or individual performance management and improvements include ways that include strategic planning, project planning and team management, implementation of projects that have been identified as necessary to achieve the stated goal, and measuring performance. However, these known approaches have several key deficiencies that negatively impact the efficiency, effectiveness, and/or productivity of the organization, group, team, and or individual and, thus, prevent peak performance.

One limitation of known approaches is a common, top-down design approach that creates breakdowns in communications and translations of goals into actions. Another way of describing this limitation is that the current art lacks an integrated and traceable process to drive, manage, and link the end-to-end process and ensure achieving effective strategic execution and implementation of desired plans and goals. Miscommunication among the participants is common, resulting in poor performance to the stated goals.

First, according to one study found in “The Harvard Business Review,” (Mar. 27, 2006) published at http://www.sullivanadvisorygroup.com/docs/articles/The %20Office %20of %20S trategy %20Management.pdf: A fifteen year study to determine root causes between a disconnect between the desired strategy and performance levels directed to enact the desired strategy found that most organizations lacked a strategy execution process. Although many organizations develop strategic plans, most fail to define a coherent approach to manage and execute the plans. Consequently, many key management processes remain disconnected from strategy. This study further revealed: (a) Many organizations don't have a consistent and effective way to describe their strategy; (b) Sixty percent of typical organizations do not link their strategic priorities to their budget, virtually ensuring that key strategic initiatives do not get funded and resources may not be supplied to deliver on the strategic plan; (c) Extraordinarily, two-thirds of human resource (“HR”) and information technology (“IT”) departments develop strategic plans that are not linked to the overall organization's strategy; (d) Seventy percent of middle managers and more than ninety percent of front-line employees' compensation is not linked to the organization's strategy; and (e) Ninety five percent of employees in most organizations do not understand the organization's strategy.

Second, current approaches typically address only one vertical activity with a vertical specific software application within the entire scope of the end-to-end process resulting in a flat, non-integrated, specialist-centric software tool. A vertical activity is, for example, strategic planning or project management, performance measurement, or engagement.

Further, known software applications are limited: They address the scope of one vertical activity, which is non-integrated and unlinked to other vertical activities. An example of a vertical, non-integrated, software application is Microsoft Project. Microsoft Project software application is used to plan projects. And, similarly, there are many vertical specific software applications that address other singular vertical activities such as measuring performance or strategic planning.

This lack of an end-to-end linked systems approach in the known art (which can also be termed a vertical solutions approach) results in a specialist-centric environment where flat, non-integrated, and unlinked static tools are available to a few highly skilled individuals who are then burdened with leading and implementing the activities. This specialist-centric approach results in bottlenecks in the process resulting in disjointed, ineffective, and inefficient execution of the strategic plan as there is an overdependence upon a few skilled persons to lead, manage, and implement projects.

Third, current approaches are not designed to work as a systematic, fully integrated, and linked end-to-end process. This results in a disparate, non-integrated unlinked processes and software application that is unable to provide the needed traceability, transparency, and accountability. This is one of the key reasons that strategic plans are not well executed.

From the Wharton School of Business article: “Three reasons that good Strategies fail, Execution, Execution, Execution.” (Aug. 10, 2005) Published in Knowledge@Wharton at http://knowledge.wharton.upenn.edu/article.cfm?articleid=1252.
From Vivendi to Webvan, the shortcomings of a bad strategy are usually painfully obvious—at least in retrospect. But good strategies fail too, and when that happens, its often harder to pinpoint the reasons. Yet despite the obvious importance of good planning and execution, relatively few management thinkers have focused on what kinds of processes and leadership are best for turning a strategy into results.

As a result, says Wharton management professor Lawrence G. Hrebiniak, MBA-trained managers “know a lot about how to decide a plan and very little about how to carry it out.” Lawrence G. Hrebiniak, “Making Strategy Work: Leading Effective Execution and Change”, Wharton School Publishing (2005) ISBN: 013146745X. “Even though they are good managers, over time they really have to learn through the school of hard knocks, through experience, which means they make a lot of mistakes.” Ibid.

This lack of expertise in execution can have serious consequences. In a recent survey of senior executives at 197 companies conducted by management consulting firm Marakon Associates and the Economist Intelligence Unit, respondents said their firms achieved only 63% of the expected results of their strategic plans. Michael Mankins, a managing partner in Marakon's San Francisco office, says he believes much of that gap between expectation and performance is a failure to execute the company's strategy effectively.

Fourth, current approaches are not designed to transform data into finished products needed for efficient execution such as, for example, presentations to request project funding, “Return on Investment” calculations, problem solving analysis, strategic plans, or performance measurements. This deficiency results in the need for additional time consuming steps to assemble disparate data into cohesive presentations.

Fifth, current approaches do not adequately address a critical success factor in strategic execution to engage the organization, team, group, or individual to obtain the acceptance (or “buy in”) and solicit the engagement necessary for effective execution of the plan and efficient implementation. Strategic plans that do not obtain sufficient engagement and acceptance by individuals and or the group have little chance to be well executed and achieve the goals of the plan.

Sixth, current approaches are too complex for effective or efficient strategic execution and are not designed from the user's perspective resulting in low user adoption rates. If software is difficult to use, implementation requires expensive and time-consuming training programs to launch and is not sustainable over time. Thus, implementing complex software will hamper effective strategic execution because of low user-adoption rates necessary to scale. That is to say, typical tools in the art require a user to search for a task assigned to them in a traditional hierarchy of data, the individual's task are buried in the project—for example, in a typical project planning tool, the user would have to first access the project planning software, find the projects that the user believes she is associated with, determine where in the time-line the project currently is, then look through each task to see if her user-initials are assigned to it.

Seventh, current approaches are often associated to a pre-defined and specific methodology in place within the organization, this so called ‘hardwiring’ makes change and adaptation difficult, and thus they are inflexible and have a shortened life.

Eighth, current approaches typically have static user-help software; this non-dynamic approach does not provide ways to adapt to each individual's needs. This results in a lackluster feature that does not support user needs for self-service help without intervention and hampers effective strategic execution across a large number of users. It also increases support costs after implementation and lowers user adoption.

Ninth, current approaches have limited scalability because: A) A top down design approach is not usable by a wide audience, and B) They are to complex to train a wide audience making it difficult to reach a high adoption rate. This hampers effective and efficient strategic execution.

Tenth, current approaches have limited or no ability to capture collaborative communications with one or a plurality of individuals and link the communications to the activity. This results in communications happening outside the software that cannot be traced and is difficult to reassemble if necessary.

Thus, there remains a need for a new approach that includes an integrated system, method, and device, and more specifically, a software tool that overcomes these known limitations in the art.

### SUMMARY OF THE INVENTION

The present invention provides a system, method, and device (including a software tool) for strategic planning and execution and for managing, driving and linking the end-to-end processes, and activities necessary to achieve the goals of the strategic plan(s) resulting in improved performance of organizations, teams or individuals.

The present invention overcomes, specifically, the aforementioned ten deficiencies.

First, a key differentiator, when compared to the known art, of the present invention is a system, method, and software tool designed and built from the user point of view instead of a traditional, status-quo, top-down approach. The present invention includes user interfaces built from the user's point of view with ease-of-use as a priority. This user-centric approach enhances the effectiveness and efficiency of executing the strategic plan by improving user adoption and usage of the software tool.

A second key differentiator is that the present invention is a fully integrated systems and method approach that provides a software tool that enables individuals, teams, groups, or organizations to achieve goals that may be associated with a strategic plan. The fully integrated approach captures all of the key activities of effectively executing the strategic plan without the need to cobble together disparate vertical software solutions or endure hard hand offs between groups. This solves the translation problem that often occurs with the current art.

A third key differentiator of the present invention is the ability to work as an end-to-end process flow. This approach results in a unique ability to effectively and efficiently drive the strategic execution. The software provides full end-to-end traceability and transparency of all activities and data elements. The software provides the benefits of accountability at all levels, real time status of Work in Process (WIP) activities and actual results by end-to-end performance measurements, and easily accessible data throughout the entire process and thereby eliminating the need for manual intervention.

A fourth key differentiator of the present invention is the ability to automatically transform one or a plurality of data elements into other data elements such as finished products necessary for effective and efficient strategic execution such as, but not limited to, presentations of proposals, return on investment calculations, problem-solving documents, strategic plans, or performance measurements. This improves productivity 401 (FIG. 3) by eliminating the need for manual intervention to assemble disparate pieces of data and by eliminating wasted productivity caused by waiting.

A fifth key differentiator of the present invention is the inclusion of a critical vertical solution within its end-to-end process called Engagement. Engaging the organization, team, group or individual to participate in the process is a missing link in the current art but it is a critical success factor in the successful execution of strategic plans.

A sixth key differentiator; the present invention is designed to instantly present vital information linked to the user. This occurs through a series of “lenses” that presents the user with only the most vital data. This greatly enhances the user experience by eliminating unnecessary work to find their tasks and is key to achieving high adoption rates to large numbers of users.

A seventh key differentiator; the present invention includes the ability to be configured by the organization, team, group or individual.

This ability allows for flexibility in using different methodologies, different business needs I.e. link from initiative directly to task, have repetitive scheduled tasks and for customizing terminology, business rules, templates, user interface, user experience, etc. specific to the organization, group, team or individual user. This allows for multiple applications of the system, method and software. This flexibility and configurability also extends the useful life of the product.

An eighth key differentiator the present invention includes an “Advanced Dynamic Assistance,” which is a unique built in dynamic help system that provides dynamic assistance to the user. As such, the Advanced Dynamic Assistant is readily available to the user in both a pull (the user requests the help) or push (the Assistant offers assistance without prompting from the user) mode, understands where the user is in the software and the user's experience level, understands where the user is within the process flow, and provides a variety of levels of assistance (for example, demos, training, or instructions).

A ninth key differentiator; the present invention is designed to be highly scalable 407 (FIG. 11) because of its user centric design that allows a wide audience to easily use the systems, methods and software and is easy to train a wide audience and thereby attain a high adoption rate. The ability to scale is essential for effective and efficient strategic execution.

A tenth key differentiator; the present invention is designed to allow collaboration and recording of all activity within the software. This improves productivity of the strategic execution and provides an audit trail attached to the activity.

Further aspects of the various preferred embodiments of the present invention include the following:

A system, method, and device—including a software tool—that is designed in such a way to drive and manage the end-to-end process flow (FIG. 2). The software tool includes, but is not limited to, strategic planning 751, surveys 16, goal setting 91, idea collection 757 and aggregation 759, portfolio prioritization 69, project management 55 and 57, task 66, and subtask 68, assignment, business case development, and ROI 763, executive presentations 765, approvals 769, investment and budget tracking 771, project implementation 773, and performance measurement 393. These activities may be applied to an organization, group, team, or individual.

A system, method, and device that provides a fully integrated system that manages the breadth of the end-to-end process (FIG. 4).

A system, method, and device (including a software tool) that provides a means for an individual user, or plurality of users, to enter the device at any point and use vertical solution of the software device independent of the other parts (FIG. 15).

A system, method, and device that provides a means of improving productivity of any combination of an individual, or plurality of individuals, or a team, or a group, or an organization through use of standardization and advanced dynamic assistance (FIG. 9) and wizards and autonomation (FIG. 12) and user centric views (FIG. 7) that are designed to remove time-wasting barriers.

A system, method, and device (including a software tool) that provides a means for input of data by templates and/or forms the data is then aggregated into summary outputs using built in formulas (FIG. 5).

A system, method, and device (including a software tool) that provides a means for adding attachments.

A system, method, and device (including a software tool) that provides a means for calculating return on investment 919 (FIG. 2) and provides a standard set of calculations with tools for the user to add their own sets of calculations (user-defined calculations).

A system, method, and device (including a software tool) that provides a means for data to be sorted and categorized, allowing a means for prioritization and weighting of goals, linking data inputs to goals, sizing and scoping data inputs and sorting data input into a matrix that is linked to goals 917 (FIG. 2).

A system, method, and device (including a software tool) that provides a means for traceability throughout all activities (FIG. 2).

A system, method, and device (including a software tool) for providing autonomation (FIG. 12) at key points in the process to ensure good process flow and eliminate wait time.

A system, method, and device (including a software tool) providing a means for “smart lenses”(FIG. 7) that recognizes the user and presents the user with the view of data that is the most value-added to that user. This is presented in a “zero click” approach that eliminates traditional drill down.

A system, software, method, and device providing for advanced dynamic assistance (FIG. 9) that is designed to recognize the user, its location within the system, and its history with using the particular section of the system. And further presenting multiple options of help to the user and providing help based on the current live-user session.

A system, software, method, and device providing a means for help wizards (FIG. 9) to instruct an individual user or plurality of users through an end-to-end step-by-step process.

A system, software method, and device that provides a means for increased productivity through the use of short-duration effort methodology 64 (FIG. 2).

A system, software method, and device that provides built-in time stamps throughout the process to track time and performance outcome (FIG. 2).

A system, software method, and device that provides for a built-in training feature set to allow a plurality of users to complete self training (FIG. 9).

A system, software, method, and device that allows for configurability that allows an individual, group, team and/or organization to configure the system to support internal terminology and allow for different methodologies (FIG. 8).

A system, software, method, and device that provides a means for collection of data from a plurality of sources for a plurality of reasons into templates 505 (FIG. 2) and at least one includes a survey template 905 (FIG. 2).

Additionally, software, the system, method, and device provides for a sandbox (FIG. 2).

A system, software, method, and device that provides a means to send and receive data to external systems 212 (FIG. 2).

A system, software, method, and device that provides a means for the user or plurality of users to assign a task(s) or subtask(s).

Tasks 66 and subtasks 68 may be assigned one time or as reoccurring tasks (FIG. 14).

A system, software, method, and device providing for an investment pool 601 (FIG. 2) that may be allocated to initiatives or projects.

A system, software, method, and device that provides a means to track project cost including, for example, labor and non-labor related costs, also provides a means to compare costs against the original budget allocated from the investment pool or other source. Further, the system, method, and device provides a means to calculate an outcome of the labor costs by multiplying the hourly rate by the reported hours (FIG. 2).

A system, software, method, and device that provides a means to search for information including documents by identifying/tagging the type of document, what it belongs to, and the creator. The system, method, and device is able to search in and/or to change search criteria to give documents, for example, a date range, by creator, by document type, and/or what it is attached to (e.g. but not limited to Sprint, project, date range).

A system, method, and device (including a software tool) that provides a means to present information for use in Analysis and to create Performance Metrics 929 (FIG. 2). The system, method, and device collects and searches to obtain and present data by multiple ways, ranges and combinations as necessary to assess performance.

### DRAWING

FIG. 1 illustrates an exemplary system for the first preferred embodiment of the present invention.

FIG. 2 is a flow diagram for a strategic execution system according to one or more embodiments of the present invention.

FIG. 3 is a graph diagram illustrating the productivity gained through a User Centric interface.

FIG. 4 is a schematic diagram illustrating the Fully Integrated feature sets of the present invention.

FIG. 5 is a flow diagram illustrating the Transformation feature set of the present invention.

FIG. 6 is a graph diagram illustrating the effectiveness of the Engagement feature set of the present invention.

FIG. 7 is a schematic diagram illustrating a filtering method of the present invention.

FIG. 8 is a schematic diagram illustrating the Configurability of the present invention.

FIG. 9 is a schematic representation of a Dynamic Assistant feature set according to a contemplated embodiment of the present invention.

FIG. 10 is a flow diagram representing the Collaboration feature set according to the present invention.

FIG. 11 is a graph diagram representing the Highly Scalable feature set according to the present invention.

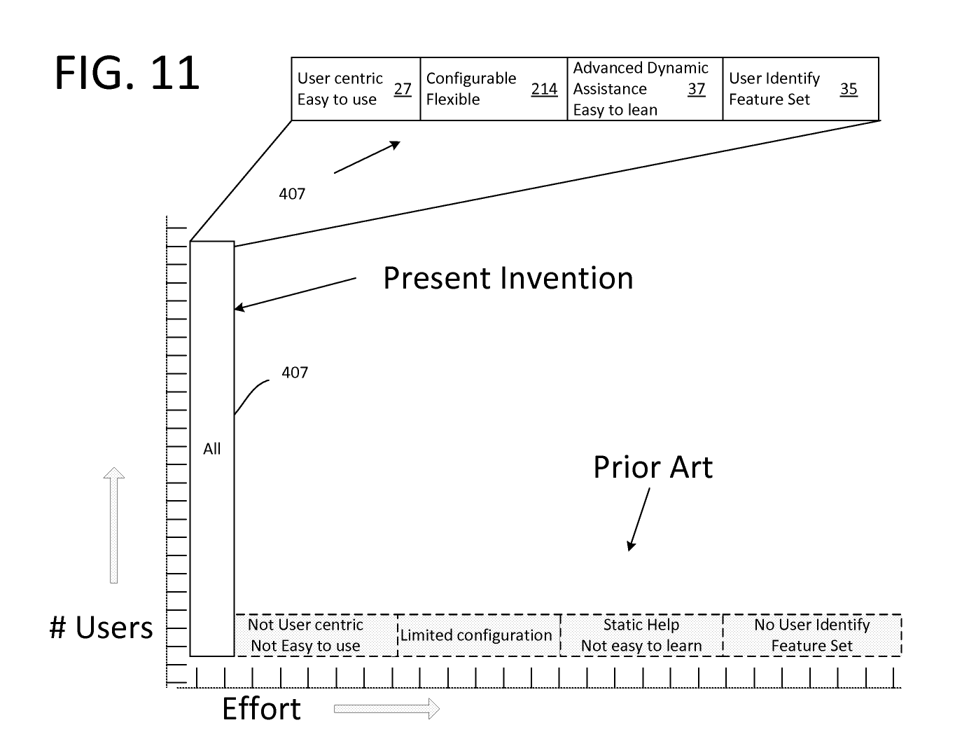

FIG. 12 is a flow diagram representing the Autonomation feature set according to the present invention.

FIG. 13 is a block diagram representing the Task and Subtasks feature set according to the present invention.

FIG. 14 is a block diagram representing the Task and Subtasks relationship feature set according to the present invention.

FIG. 15 is a block diagram representing the multiple uses feature set according to the present invention.

### DESCRIPTION OF THE INVENTION

Possible preferred embodiments will now be described with reference to the drawings and those skilled in the art will understand that alternative configurations and combinations of components may be substituted without subtracting from the invention. Also, in some figures certain components are omitted to more clearly illustrate the invention.

The following disclosure includes definitions of selected terms used. The definitions include various examples and/or forms of components that fall within the scope of a particular term and can be used to implement the disclosed methods. The examples are not intended to be limiting and both singular and plural forms of terms may be within the definitions.

The term “software,” as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, feature sets, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, PHP, SQL, APIs, SDKs, assembly, firmware, microcode, and/or other languages and tools. Software, whether an entire system or a component of a system, may be embodied as an article of manufacture and maintained or provided as part of a computer-readable memory as indicated previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

The term “user,” as used herein, includes but is not limited to one or more persons, software, computers or other devices, or combinations of these. A user may also be a real person that is an individual, or is part of a group, organization, company, team or other arrangement of people whether formed formally in a legal entity or otherwise.

The term “data-element,” as used herein includes, but is not limited to, the following uses, for example:
A3 A standardized software template for capturing a plurality of data elements for the purpose of solving problems and proposing improvements.
Assistant A software feature for assisting the user.
Autonomation A software feature set that detects that an abnormal situation has arisen, stops that situation from progressing, and alerts to allow human users to investigate the root cause of the abnormal situation.
Big Board, Big Picture A representation of the status of the strategic execution status. It may include but is not limited to real time status of other data elements such as for example, WIP, status of Initiatives, Sprints, Tasks, Subtasks, users, progress to goals, ROI, budget, investment pool.
Budget A set dollar amount for use in executing the plan.
Business Rule Applies to a variety of aspects and feature sets of the present invention. A business rule is a rule of a business, company, or corporation. It is a rule that defines or constrains some aspect of business and always resolves to either true or false. Business rules are intended to assert business structure or to control or influence the behavior of the business. Business rules describe the operations, definitions, and constraints that apply to an organization. Business rules can apply to people, processes, corporate behavior, and computing systems in an organization, and are put in place to help the organization achieve its goals.
   For example a business rule might state that no credit check is to be performed on return customers. Other examples of business rules include requiring a rental agent to disallow a rental tenant if their credit rating is too low, or requiring company agents to use a list of preferred suppliers and supply schedules. Root cause Analysis.
Costs Costs are tracked against an initiative.
Document (attachment) An external document that can be imported into the system and tied to a variety of data elements.
Goal/Objective Typically an output of the planning stage and placed on the Matrix.
Hours Data element used for tracking hours spent on an assigned tasks by one or a plurality of users.
Idea A business or customer requirement.
Initiative A High Level scope of work, typically linked to a goal but can stand on its own.
Investment Pool Pool of funds available for distribution to approved proposals, goals, initiatives, sprints, tasks and subtasks. Typically linked to a budget.
Matrix A software template for collecting data elements such as goals and ideas for the purpose of executing one or a plurality of plans Multiple matrixes can be simultaneously in flight at one time.
Message Messages within the software, which may be linked to other data elements to allow for user collaboration. Examples include but are not limited to tracking the conversations, and providing notifications via email or text that a new message is present.
Notification/alert Alert or notification that is sent to a linked user or users either through push (triggered event that determines this person needs to be notified) or pull (a personal subscription to a triggered event) and can be delivered in a variety of ways (email, system notification, text message).
Organization Track organizations that are working within the system.
Plan Used to plan how the matrix will be driven to completion.
Rates (hourly) Labor rate for a user
Risk A risk identified by one or a plurality of users.

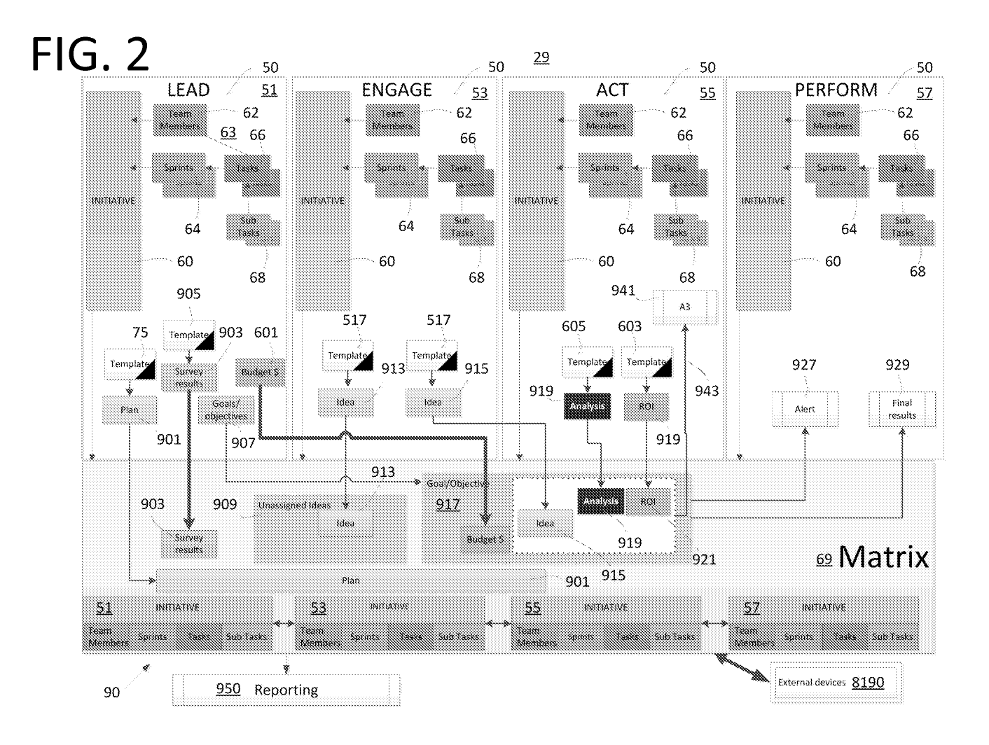

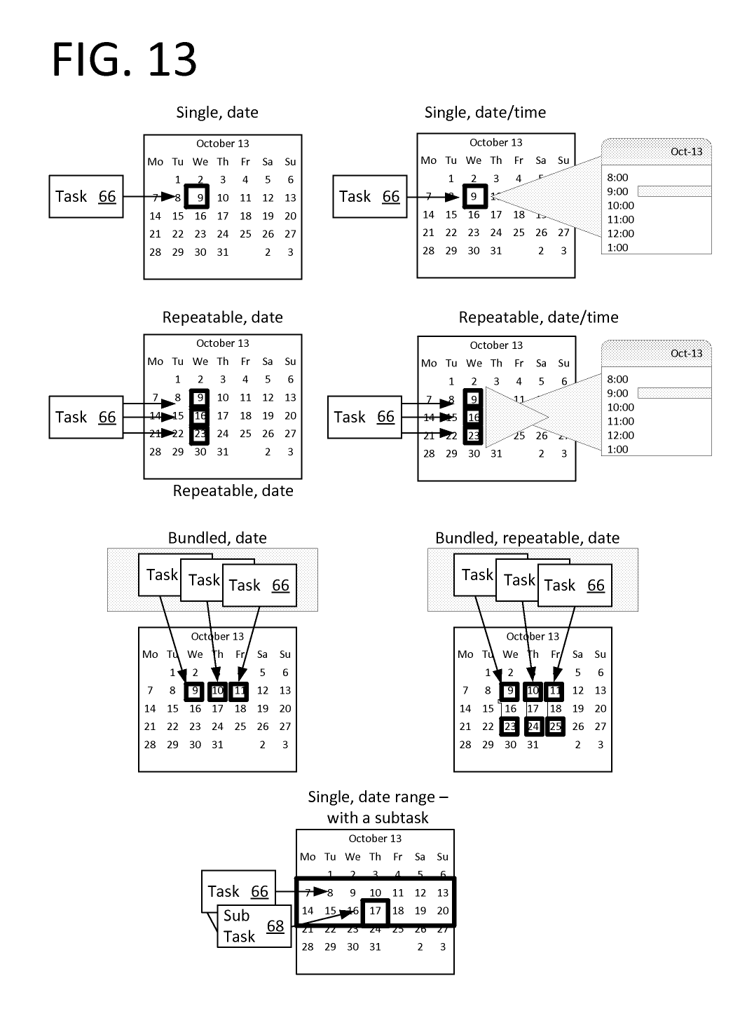

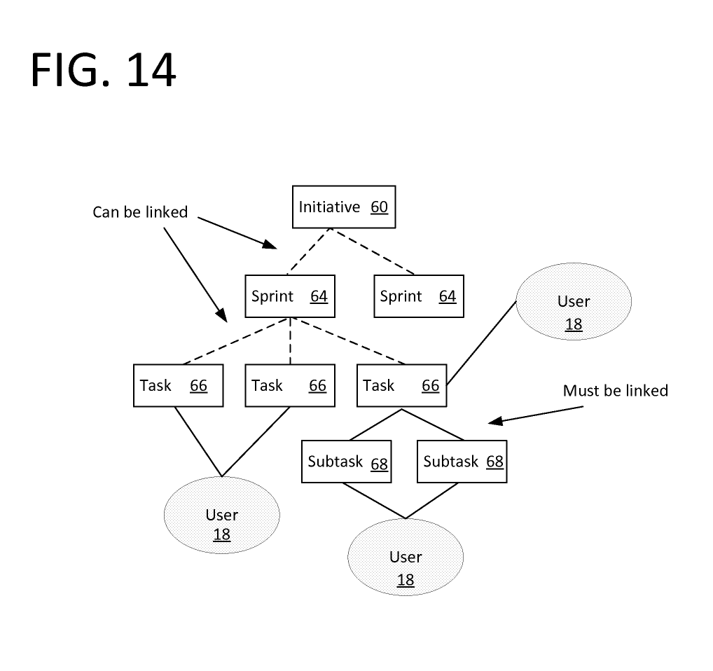

May be associated with, for example, an initiative, sprint, task, subtask, goal or objective.
ROI Return on investment software and calculator for the purpose of calculating ROI.
Role Role of a user (examples include but are not limited to stakeholder, team leader, team member.
Sprint A set time period during which tasks are completed. One or more sprints are completed within an initiative and tasks and subtasks are assigned within those sprints to complete work.
Sub Task A work item assigned to one or a plurality of users within a sprint and linked to a task. Allows for assigning the task, accepting the task, tracking items within the task, and marking the completion of the task.
Subscription A user subscription linked to a data element or event within the software. Examples include but are not limited to threshold events, initiative status.
Task A work item assigned to one or a plurality of users within a sprint. Allows for assigning the task, accepting the task, tracking items within the task, and marking the completion of the task. FIG. 13 shows the various ways that tasks and subtasks. can be scheduled. FIG. 14 shows the relationship of the tasks and subtasks and users.
Template A predetermined feature set or subset that includes pre-defined parameters, inputs, outputs, and graphical arrangement of element to solicit ease of use by a user. Examples of contemplated templates include pre-defined user interfaces (FIG. 2) for Plan, Ideas 517, ROI 603, Analysis 605, A3 941, and sprints, for example.
Timestamp A date/time/person stamp to track when an event happened or a data element was saved. Allows for tracking what occurred, when to allow for calculating time spans for events.
User User that is working within the system. Examples include but are not limited to employees, vendors, clients, contractors, consumers, and patients.
View A user specific view of the data most vital to them within the system.
Weighting Weighting used of the ideas
WIP Work in Progress. All work that has been started but has not been completed.

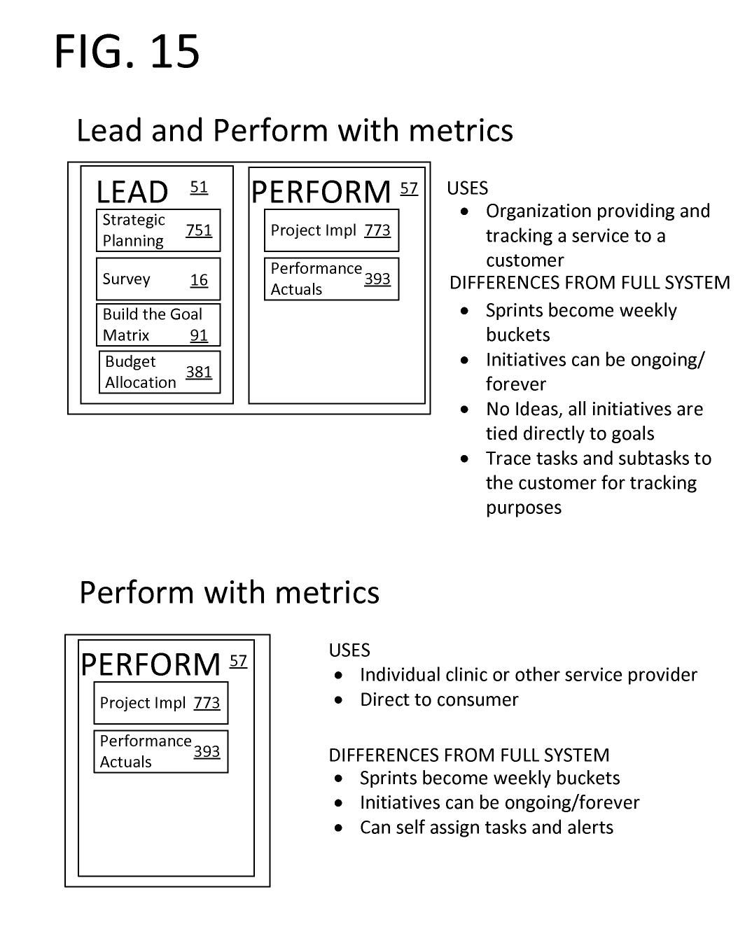

The present invention is discussed in relation to an organization, such as a business entity, but those skilled in the art will appreciate that the present invention readily adapts to many different types of users both within an organization, such as a business entity, but also external clients, vendors, individuals, teams, groups, or other such collections of people that work together or even individually to achieve some sort of goal. For convenience only, in the embodiments discussed herein, the term “organization” will be used—but it should be understood that individuals, teams, groups, or other collections of at least one person (user) could easily use the present invention. See FIG. 15 for two of many possible scenarios for alternate configurations and usage of the system. One such implementation allows for usage for organizations that provide and track services for customers using only the LEAD and PERFORM stages. Another such implementation allows for individual organizations or users to track their initiatives using the PERFORM stage only.

### Software Designed to Run on a Computerized System

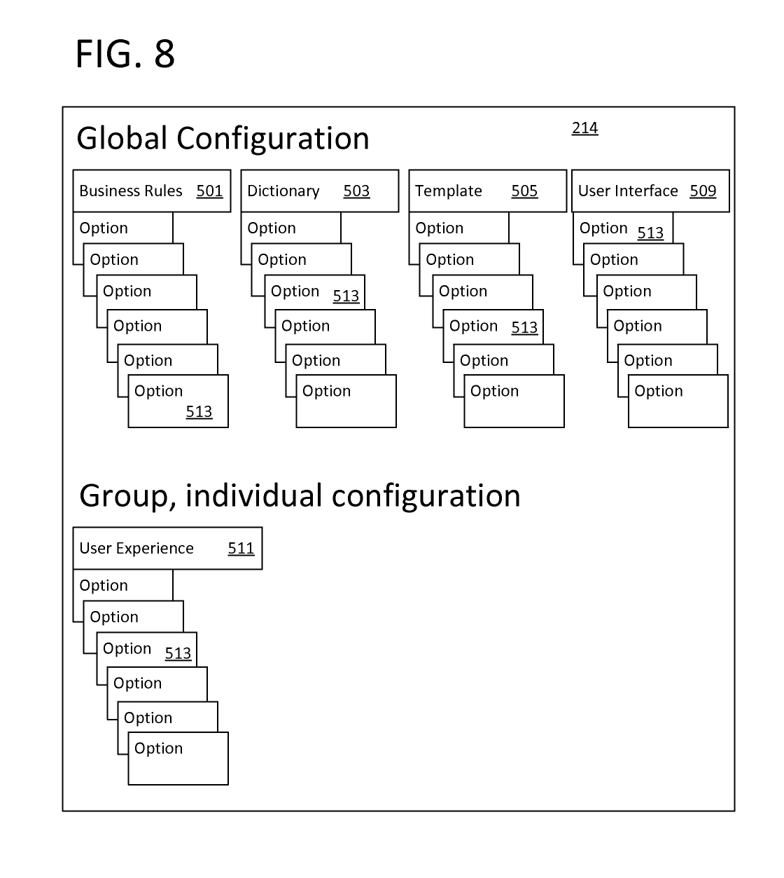

In one preferred embodiment, the present invention contemplates a software tool to be run on a computer system that has at least one user, but preferably a plurality of users. The software is designed to enable an organization, team, group, or individual to manage disparate processes with an over-riding feature of linking and executing strategic plans and budgets to activities within the scheme of the end-to-end process and specific tasks and subtasks to be performed by unique individuals, teams, or groups within the organization (FIG. 2). The software tool, recognizing that any individual user will have a unique experience and comfort level with the software tool, further is configured FIG. 8) to enable options 513 for user-customizable business rules 501, terminology 503, templates 505, user experience 511, and user interface 509. This allows for the individual or organization to tailor the software to suit their business needs and increases the adoption (acceptance rate by users is increased). Further, real-time presentation of data enables the system to create a flexible table that adjusts to the user input in real-time (FIG. 2).

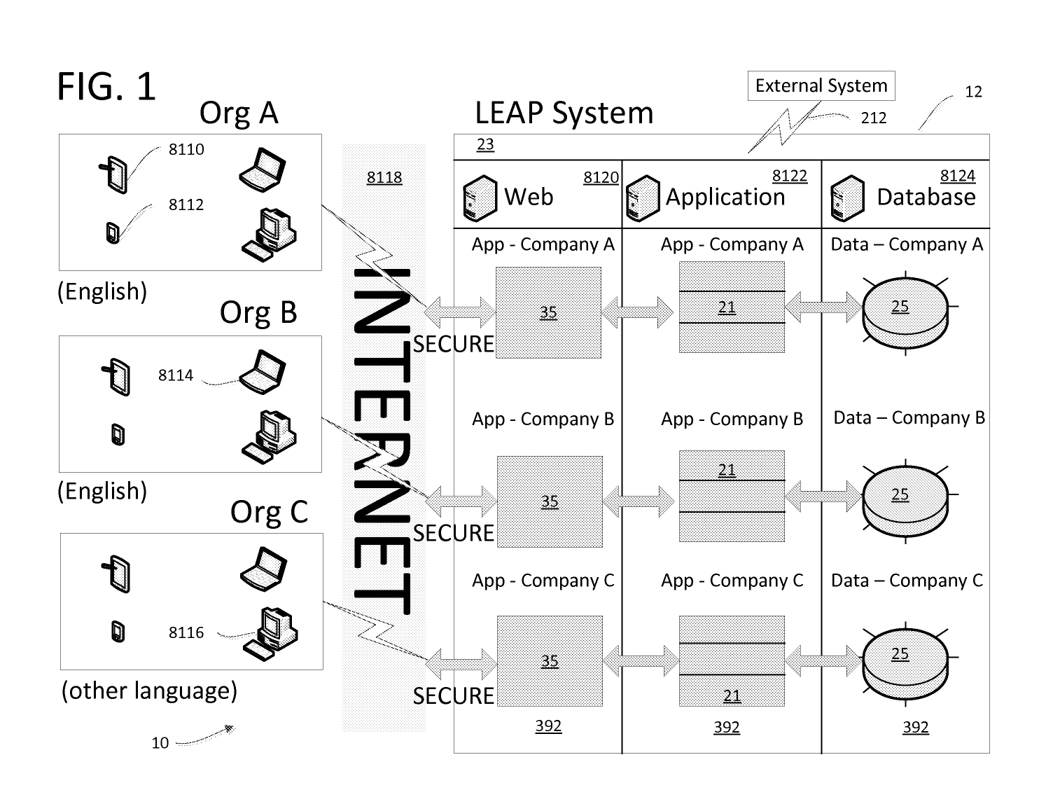

FIG. 1 illustrates an exemplary system for a strategic execution system 10, according to one or more embodiments of the present invention. As shown, strategic execution system 10 includes client devices 8110, 8112, 8114, and 8116, and software 392 running on computer system servers 8120, 8122, and 8124.

In the embodiment illustrated, strategic execution system 10 is an online service that is connected to client devices 8110, 8112, 8114, and 8116 over Internet 8118. Software 392 is a software module running on computing servers that includes a processor and memory and controls the overall operation of strategic execution system 10. Alternatively, the connection may be over Wide Area Networks (WANs), Local Area Networks (LANs), or any other system of interconnection enabling two or more devices to exchange information. Client devices 8110, 8112, 8114, and 8116 allow access to web server 8120 via browsers such as Microsoft Internet explorer, Apple Safari, Mozilla, Firefox or any other browser that supports HTML and JavaScript that may allow network access via the web. Examples of client devices 8110, 8112, 8114, and 8116 include personal computers and mobile computing devices.

In the embodiment illustrated in FIG. 1, users of strategic execution system 100 are depicted as users of client devices 8110, 8112, 8114, and 8116. Users of client devices 8110, 8112 are shown as being registered (i.e., having a user account) from within user organization A, and user of client device 8114 is shown as being registered (i.e., having a user account) within user organization B, and user of client device 8116 is shown as being registered (i.e., having a user account) within user organization C. Only two organizations are shown in FIG. 1 to simplify the description but in practice there may be a large number of organizations with one or many client devices and users within each. Attributes of the organizations are managed by application manager 8122. The data path is shown from the user device through to the web server 8120, application server 8122 and database server 8124.

As is described in detail herein, an organization is a collection of users and content generated by one or more users. Servers 8120, 8122, 8124 maintains isolation between organizations so that a user registered in one organization has the ability to see public information of other users in that client organization—but not any information in a different organization.

Web server 8120 is a web server that uses protocols and/or applications including Hypertext transfer Protocol (HTTP), File Transfer Protocol (FTP), Extensible Messaging and Presence Protocol (XMPP), or other similar connection protocols. The operating system may be Windows, LINUX, SUN Solaris, Mac OS, or other similar operating system. Users create an account on web server 8120 and are registered in an organization as described above. Application processing from client devices 8110, 8112, 8114, and 8116 is directed to web server 8120 through Internet 8118.

The operating system for the servers may be Windows, LINUX, SUN Solaris, Mac OS, or other similar operating system.

For purposes of explaining the contemplated software tool and intrinsic method of the various preferred embodiments, a conceptual feature set is used herein as a means for explaining the function and construct of the software, but should not be used as a literal, limiting construct of software development. Broadly, feature set, as used herein refers generally to describing the functionality of the software tool into discrete, perhaps independent, feature sets as a way to describe aspects of the present invention. Conceptually, feature sets represent a serration of concerns or functions to achieve a result or to transform data or data-elements. Concerns or functions are separated (at least conceptually) so that feature sets perform logically discrete functions or operations or steps. Feature sets may interact with other feature sets of the system or may be highly independent from other feature sets. Conceptually, a feature set can operate independently to another feature set, or can use output from another feature set to trigger a particular feature set to operate. At least one feature set, or as contemplated conceptually herein, several feature sets cooperating and/or operating autonomously compile to construct the executable application program of the software tool of the present invention.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data that can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

### First Preferred Embodiment

Some of the preferred and contemplated embodiments of the present invention specifically contemplate a method or methods (such as a computer-implemented method) to accomplish organizations strategies and goals by at least on user using at least one computer system.

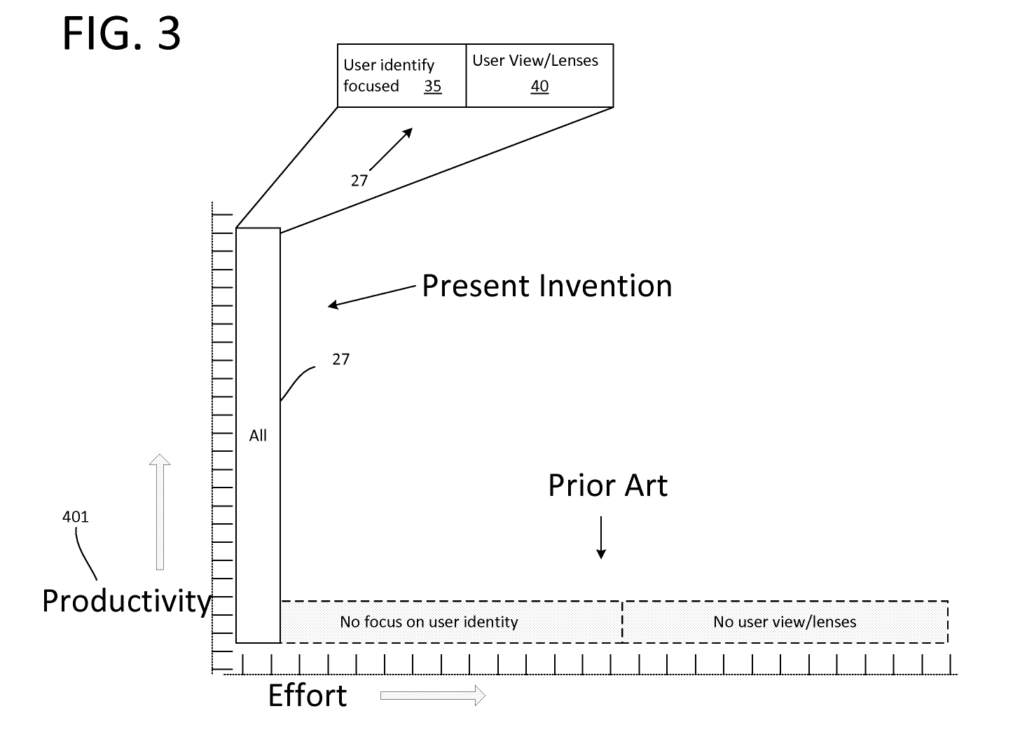

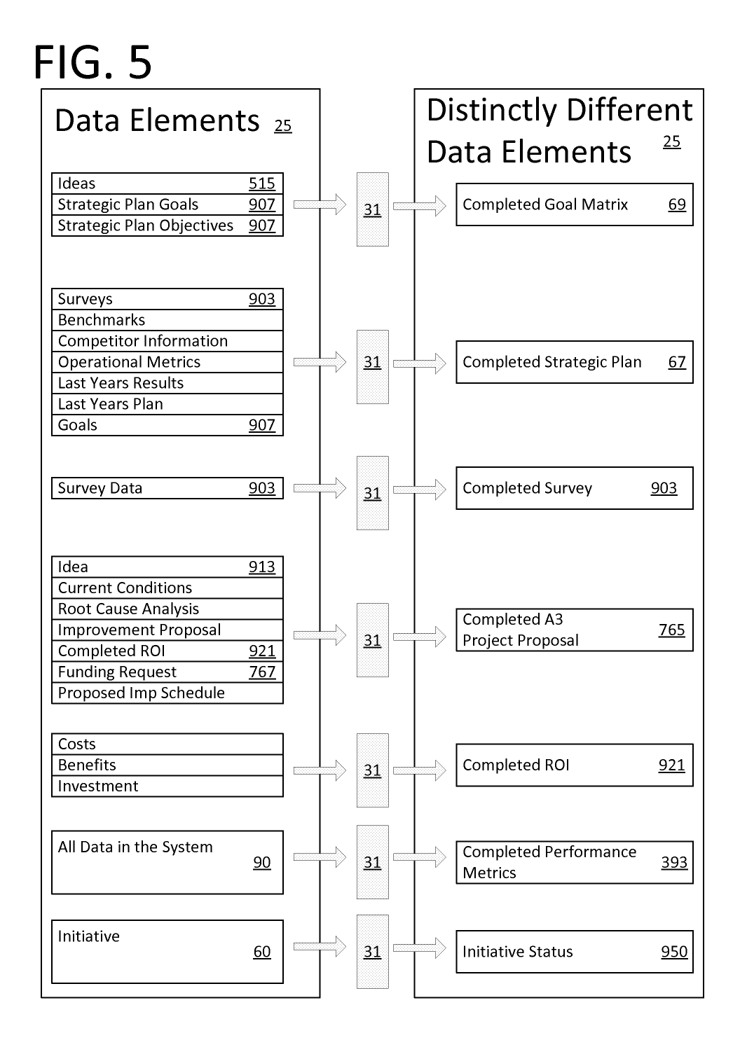

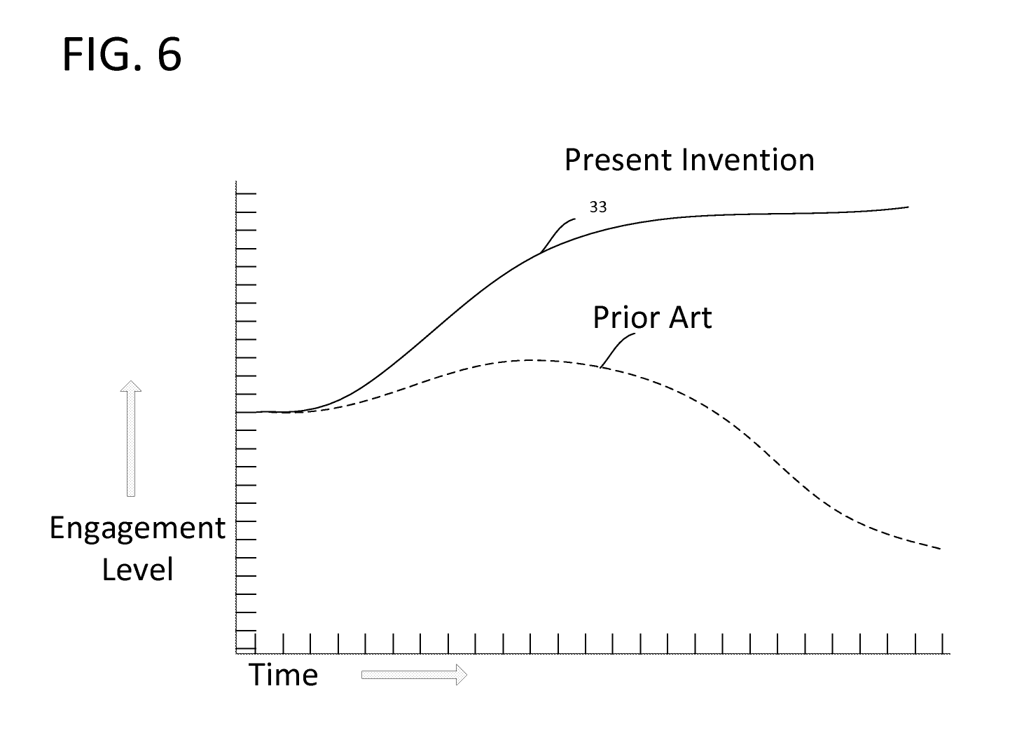

Referring generally to FIGS. 1, and 2, in a first preferred embodiment, one method 10 includes the steps of: Providing a multi-user software tool 12 comprising a plurality of feature sets 21 whereby each feature set, respectively, is configured to send and receive operable instructions to the computer system 23, store a plurality of data-elements 25, and send and receive any combination of the plurality of data-elements to and from any combination of the plurality of feature sets. This software tool further comprises: A user-centric interface feature set (FIG. 3) configured to prioritize user-specific data-elements and configure a user's interface to present the prioritized, user-specific data-elements associated with that user; An end-to-end process flow feature set (FIG. 2) configured to create relationships between discrete data-elements and collect a plurality of data-elements based on a rule set defined by the relationships; A transforming feature set (FIG. 5) configured to manipulate related data-elements into transformed data-elements and outputting the transformed data-elements to at least one user; An engagement feature set (FIG. 6) configured to enable a plurality of users to create new data-elements and to associate or link any new data-element to a goal, the engagement feature set further configured to track progress of the new data-element relative to the goal; And, a user-identity feature set 35 (FIG. 1) configured to identify the at least one user and determine what operation in the software the at least one user is interfacing and determining an experience level for the at least one user and provide on-demand assistance to the at least one user based on the experience level and the operation; And, using the multi-user software tool to attain at least one organizational goal or strategy 907 (FIG. 2).

The at least one organizational goal or strategy is characterized by one or more initiatives, one or more sprints, each one or more sprint including at least one task, and the at least one task may include one or more subtasks. At least one user is identified to accomplish at least one task. An alternative configuration allows for goals, initiatives, tasks and subtasks to be linked in a variety of ways to meet market, channel or customer needs (FIG. 14).

An example of one possible configuration, a new initiative begins with a user naming the initiative, for example “Create Strategic Plan” selecting users to participate in the initiative, for example “all executive stakeholders” and creating one or a plurality of sprints linked to the initiative, for example a Sprint can be “Executive Team to agree on Strategic Plan template to use for planning”. Within the sprint a user can create one or a plurality of tasks—for example, the tasks could be “Select and propose Strategic Plan template” and “agree on Strategic Plan Template”. The user then assigns this task to one or more users, (in this example the users assigned are an Executive Staff member and himself). The now-assigned (new) users then receives the tasks called “select and propose a Strategic Plan template” and “agree on strategic plan template’. The new users accepts or rejects the task. If the task is accepted, the user can carry out the task himself or can optionally assign one or more subtasks to other users that he asks to contribute to completing the main task assigned to the user.

Next, the user assigned to the task and one or a plurality of subtask users begins the activity to complete the task. In this representative example, the “do task” assigned to the user is to “Select and propose a Strategic Plan Template”. Here the user can utilize pre-defined templates, or on previous strategic deployment plans, or create a brand new plan. Once this specific task is done, in this example, the user indicates that it is complete. One or a plurality of tasks may be within one Sprint. Once all tasks within the Sprint are completed or alternatively rejected this ends the sprint. Other sprints may follow, and ultimately the initiative ends. Performance is measured at any point in the process and with any data element.

Another aspect of the present invention is the ability to generate surveys 903 (FIG. 2). Surveys are used to solicit, for example, ratings, top problems and suggestions from users, for example, organizations, customers, vendors, individuals, teams. The system can assist in generating surveys by using a database of pre-existing, pre-defined survey questions and allowing a user to generate his or her-own survey questions. The survey, once created, is distributed to the users, which may be for example stakeholders, groups, teams or individuals, according to a given customizable business rules (all users, all management users, all users in department x, for example). The results are collected and may be analyzed for use.

As discussed above, a plan to be executed consists of many initiatives, sprints, tasks and subtasks. For each task and subtask there is a unique user (person) assigned to this task. Other information that the task or subtask may carry includes relationship to other events (precedent tasks, consequent task, for example), whether it is a critical path task (timeline), expected timebox to complete the initiative, sprint, task or subtask budget 601 allocated to the proposal, initiative, sprint, task, or subtask, risk, to a user having authority over the initiative and other information. Thus, the system can look at any given goal, initiative, sprint, owner, task or subtask to determine whether it is completed, on-time, late, on-budget and other conditions. With this information, additional business rules can be associated and when a triggering event (i.e. task complete, or task is late, project proposal is ready for review, performance metrics business rules exceeded) occurs, a series of rule-fired events can be executed. If the task is complete, then other consequent tasks or subtasks can enable the relevant user to view those tasks or subtasks. Or, if the task or subtask is late, an alert 927 (FIG. 2) to a stakeholder or project manager's computer device, for example, can be generated. These alerts can take many forms and frequencies, and can be custom configured by the recipients choosing the triggering events, the business rules for the event and the manner of delivery from e-mail, to text messages, to pop-up windows, from immediate alert once a day to once an hour, or any other method that would be well understood in the art.

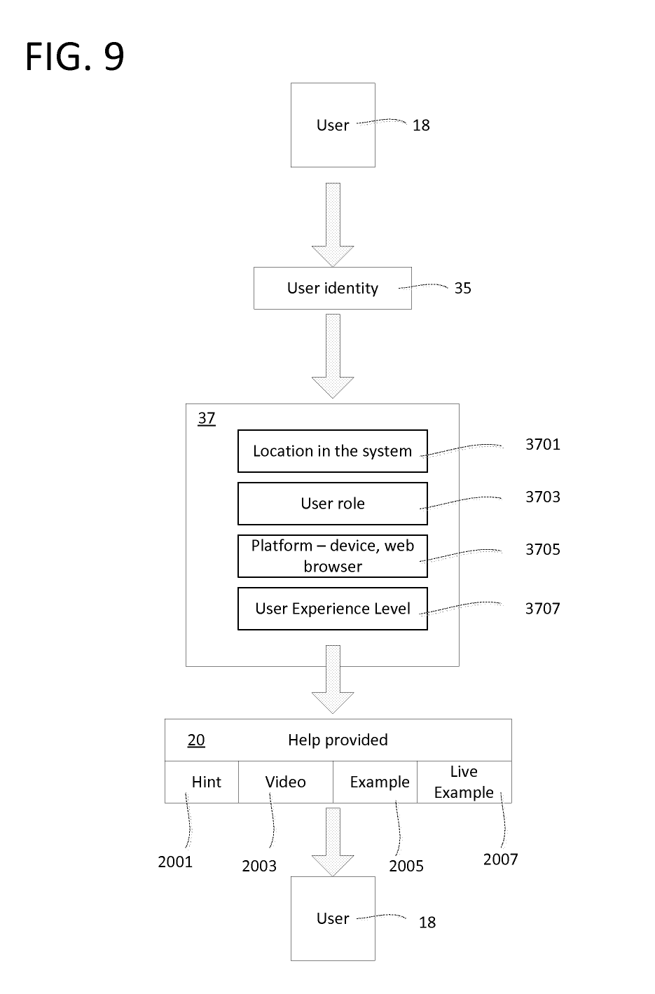

Another aspect of the present invention includes providing assistance (FIG. 9) to any one user or any given number of users from a plurality of users 18. This refers to a dynamic assistant feature set 37 wherein the present invention recognizes that each unique user has a unique skill level and unique need for help on the operation of the software and other information provided in a way that is meaningful, but that one static method of displaying such help or information is not helpful to most users. Therefore, the present invention provides for a dynamic help system feature set. Specifically, the present invention determines the context of where the user is accessing the assistance (dynamic assistant) feature set of the software. Here, a heuristic determines what specific software activity the user is accessing 3701, the role of the user 3703 (i.e. team leader, team member, vendor, client, stakeholder, etc.), what platform 3705 the user is using to access the system (smart phone, tablet, terminal, pc, laptop, etc., and experience level of the user 3707 as determined by for example but not limited to system usage, system training, certificates, and other data. The Advanced Dynamic Assistant 20 then provides various levels of help from a basic hint 2001 (for example in a pop-up window), to a simple example 2005, to a demonstration of how to perform the task in real-time with the task the user is attempting to accomplish 2007, to a training program that is off-line from the task being attempted 2003.

The data elements of the idea, entered earlier in the process, are available at any stage due to the full integration of the software (FIG. 2). Additional data elements are entered, for example, analysis data and return on investment into templates and forms provided by the software. Once the idea 915 is vetted within the initiative 60 the data is transformed into a proposal format 941 by the software. The user submits the proposal to the approver, which, for example, could be a stakeholder or other executive. The alert feature of the software 927 (FIG. 2) will send, by electronic means, the proposal to the stakeholder. The stakeholder is auto alerted by the software that a project proposal linked to their user name is ready for review and approval. The recipient of the proposal, which can be, for example, a stakeholder can review the finished forms, templates and attachments that allow a review and approval. If there is a request for funding, the stakeholder can assign budget dollars 601 (FIG. 2) from the investment pool residing internally or externally to the software. The stakeholder can view the available budget dollars and assign dollars to the project proposal. The software will automatically reduce the available investment pool by the like amount and assign it 771 to the project. The software may make external updates to external budget or other systems 211 (FIG. 1) if this is the desired configuration. The stakeholder can approve 769 the proposal 765 with funding, approve without funding, reject, or reject with questions. The alert feature of the software will send an alert to the user who submitted the proposal 765 with an approval 769 with or without funding, rejection with or without questions. The user submitting the proposal has the opportunity to resubmit the proposal 941 (FIG. 2) with improved information to the stakeholder for reconsideration.

Once a proposal is approved, it moves to the implementation stage (FIG. 2), which may be called the perform stage or an alternative, user-defined name 503 (FIG. 8).

The standardized process repeats. An initiative starts, linked by the software to previous initiatives linked to the goal inked to the plan. The initiative may include one or a plurality of time-box events and one or a plurality of individuals such as but not limited to team members, project managers, sponsors, and stakeholders. Tasks are assigned by one individual or group and accepted by another individual or group 66. Subtasks are assigned by a task owner and accepted by an individual or group. Subtasks are autolinked to the task by the software 68. In the perform stage 50 (FIG. 2) the approved project is implemented using the above process.

Performance at any stage of the end-to-end process of any data element, individually or in combination with other data elements, is tracked by the software 929 (FIG. 2).

The performance results can be obtained real time by one or a plurality of users and sorted, combined and aggregated in whatever fashion as desired by each user 393.

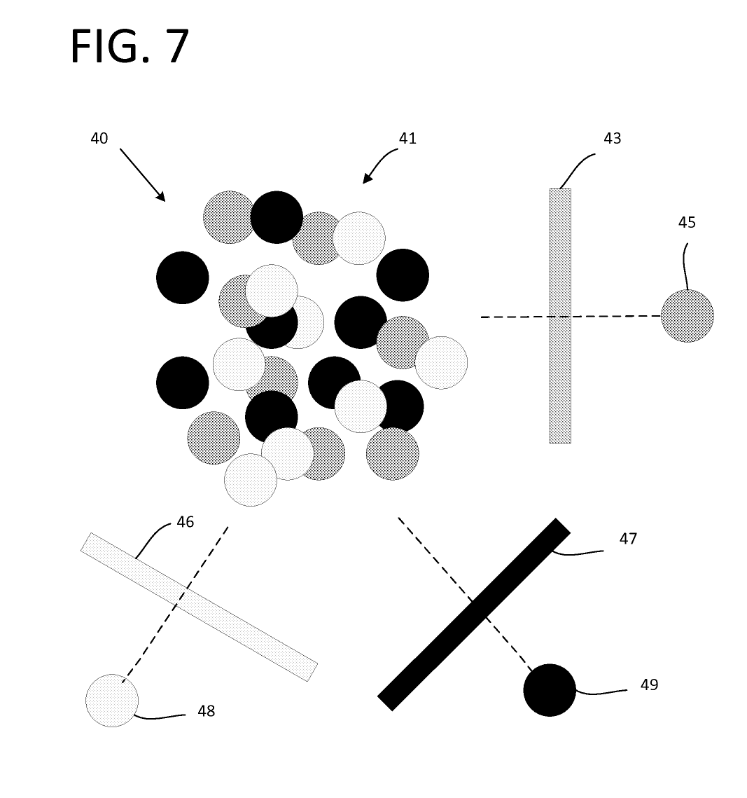

Because there may be a plurality of data elements for one single plan, and given that an organization may have a plurality of plans, any given single user of a plurality of users of the system of the present invention may have dozens of data elements in which they are assigned, associated with and or linked to. However, for those data elements assigned, associated or linked to a given user (user x), a portion of those tasks may not yet be germane, as they may depend on an action not-yet performed by another user (user y). Managing and displaying all the data elements assigned, associated or linked to a single user is complex. Accordingly, the present invention contemplates a software tool termed ‘lenses’, (FIG. 7) which filters what a given user may see at any given time. Each lens is configured according to the needs of the user and their assignment, association or linkage with the data element. For example, a user, for example a stakeholder, lens may enable the stakeholder to see all the Initiatives linked to her sponsorship, all proposals waiting for review and approval and investment dollars remaining from the investment pool. A user, for example a team member lens, however, may only provide access to those germane tasks or subtasks assigned to that specific user. Thus, if task “a17” is assigned to user x, but task “a17” cannot be performed until task g27 is completed by user y, then the user x lens may not show task “a17” until such a time that user y completed the precedent task. This criteria and rules can be established in a flexible nature.

FIG. 7 illustrates the lens filtering 40 of the present invention. Any number of a plurality of users, here three users, user x, user y, and user z are represented as reference numbers 45, 48, and 49, respectively. These users have any number of a plurality of tasks or subtasks assigned to them from a Sprint 41, some of the tasks are not germane at a given time index, as described above. Each user has a unique lens associated, which filters non-germane tasks, and other user's tasks from view. Thus user 48 has a lens 46, and user 49 has a lens start here 47, and user 45 has a lens 43. Each user then sees only his or her specific (and germane) tasks and is not lost in the detail of viewing every other user's tasks This FIG. 7 is merely illustrative of this aspect. The lenses are software tools that sort the tasks according to their association or linkage to the specific user as well as criteria and characteristics assigned to the users.

### A Second Preferred Embodiment

A second preferred and contemplated embodiment of the present invention is a software tool consisting of machine-readable code arranged in a series of computer-executable instructions.

FIG. 2 describes various contemplated stages 50 according to the second preferred embodiment of the present invention. The stages include Lead 51, Engage 53, Act 55 and Perform 57. Each of these stages are further described, below. The software tool is configured to perform multiple, simultaneous iterations of these four stages.

Generally, each of these stages 50 (Lead 51, Engage 53, Act 55 and Perform 57) include similar components. These similar components are generically represented in FIG. 2. FIG. 2 shows for each phase an initiative 60. As such, the initiative 60 includes, in logical order, Start, Create initiative, create Sprint, Assign tasks and subtasks 63, Submit completed tasks, Finalize Strategic plan 901, and Complete Goal Matrix 69. Input and output to this generic initiative 60 include at least one Sprint and preferably a plurality of team members 62 potentially available for the stage based on identified tasks 66 and subtasks 68, which are arranged temporally and link to a sprint 64, for example.

Still referring to FIG. 2, the software tool is configured to manage at least one, and preferably, many initiatives 60 and each initiative includes one or more team members 62, sprints 64, tasks 66, and subtasks 68. For each task and subtask there is a unique user (person) assigned to this task. Other information that the task or subtask includes association and/or linkage to other data elements (i.e. initiative, sprint, goal, precedent tasks, consequent task, for example), whether it is a critical path task (timeline), expected time-to-completion, budget allocated, sponsor, stakeholders, vendors, clients and/or any other identities that the user and/or organization might assign to it. These various identifiers enable the software tool to include feature sets that then sort and present information to the user or other users based on desired outputs using these various identifiers to sort and/or prioritize. Further, the system can look at any given goal, initiative, sprint, owner, task or subtask to determine whether it is completed, on-time, late, and other conditions. With this information, additional business rules can be associated and when a triggering event (i.e. task complete, or task is late, project proposal is ready for review, performance metrics business rules exceeded) occurs, a series of rule-fired events can be executed. If the task is complete, then other consequent subtasks can enable the relevant user to view those subtasks. Or, if the task is late, an alert 927 (FIG. 2) to a stakeholder or project manager's computer device, for example, can be generated. These alerts can take many forms and frequencies, and can be custom configured by the recipients choosing the triggering events, the business rules 501 for the event and the manner of delivery from e-mail, to text messages, to pop-up windows, from immediate alert once a day to once an hour, or any other method that would be well understood in the art.

These stages 50 are steps or operations that are linked and integrated vertical solutions and include Lead, Engage, Act, and Perform. The software provides for a consistent and standardized process and method throughout the end-to-end process flow to ensure continuity of experience to the user. Data elements such as Initiatives, time-boxed activities (i.e. Sprints), tasks, and subtasks, standard forms, and templates can be linked together by the software to provide full traceability of all data elements and activities.

In the LEAD STAGE 51, the software is configured to enable a first user to start an initiative 60 beginning with a title, for example. A title might be, for example, “new strategic plan.” This first user selects team members from the team member list 62, this list may be pre-existing in the system or may be contemporaneously inputted by the user into the software. This first user starts a time-boxed event, which may be called a Sprint 64 or alternative name as desired or decreed by the organization or user. The user assigns tasks to one or to a plurality of team members. And, the team member assigned to that task or subtask must accept each task or subtask.

During the engage stage 53 the software is configured to enable input to the existing or new initiative and solicit input from additional users through tasks and subtasks for example, other people within the organization that have stake hold in the overall stated goal—these may be employees that are in a department, cross-departmental team member, subordinates, superiors, customers, vendors, or other contributors—can be inputted to the initiative 60. Other details will be appreciated in view of the discussion of FIG. 2, below.

The action or act stage 57 the software is configured to enable the user of existing or the creation of new initiatives and time boxed events (i.e. Sprints or alternative names) that hold the specific tasks and subtasks, which are assigned to individuals or groups by communicating those tasks to each user in the system that has an assigned task or subtask. Initiatives and time boxed events with tasks and sub tasks with collaborations, communications and attachments are monitored for progress, and feedback to stated goals, objectives, and financials also is performed during this stage.

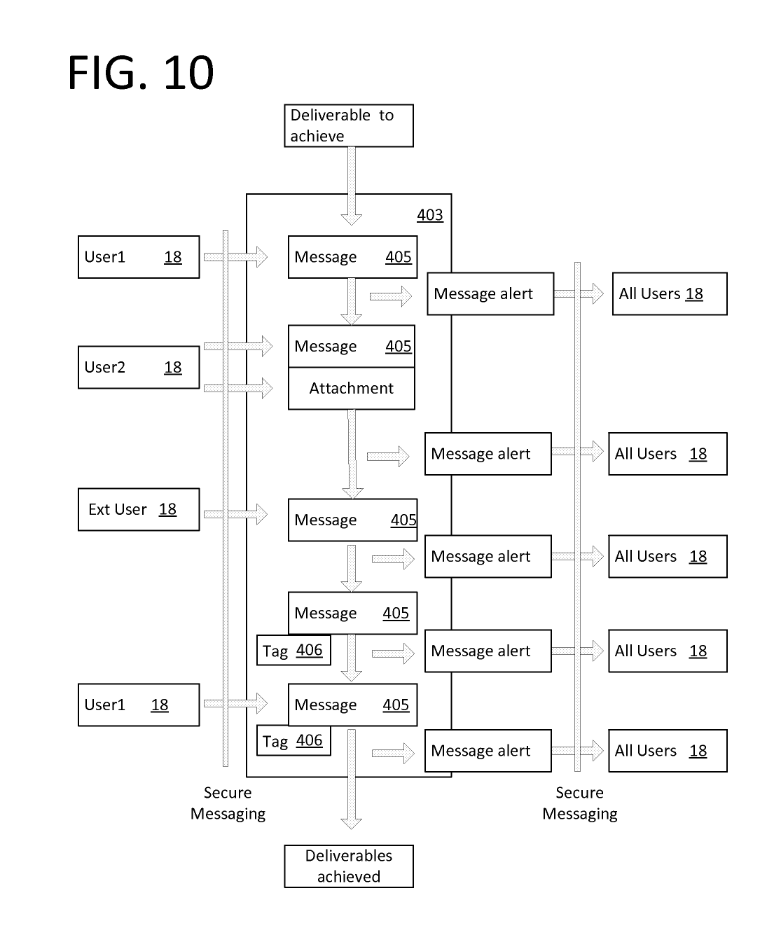

Collaboration (FIG. 10) provides the ability to message other team members, individually or as a group or subset of a group and ties the conversation to the initiative and to lower data elements within the initiative, for example, a task. Each time a message is sent the receiving user(s) are notified via e-mail or text that they have received a message. Further, the conversation is saved for viewing at a later date and messages can be tagged to identify solutions or other important information to search for later. Also collaboration provides the ability to enable uploading of documents and attaching them to a message, for example.

The collaboration 403 feature of the present invention utilizes messaging as a means to an end to solve a problem and is tied to a task, a project, or any data element or activity at any level. It enables a user to tag 406 or otherwise provide searchable elements to a message and relates that message to the specific activity. This tag feature of the collaboration feature set is a searchable data element. The message 405 can have other tags and/or other attachments to make collaboration more effective. In contrast, some prior-art systems including Yammer, a proprietary software tool that enables communication within an organization in a similar fashion to popular social networking tools such as Facebook, does not include the tag feature or the collaboration feature of the present invention. In the present invention, the tag feature of the collaboration feature set is tied the system and is presented to the user, but is not based or tied to the particular user. In the present invention the tag feature is activity driven (to achieve an outcome).

This tag feature allows a user to tag a message. The message can be tagged by the sender or the receiver of the message. Multiple tags may be assigned to a message. The purpose of the tag feature is to allow users to indicate something about a message that can be searched for later. For example, a user can tag a message as a problem. Some messages will be exchanged with the team and ultimately a solution to the problem is determined and implemented. Then, the last message in the set of messages relating to this common theme can be tagged as the solution. A solutions archive can be maintained and future problems can be compared to known solution in the archive. This enables future users/tasks to benefit from previous problem/solutions.

Further in the action or act stage 57, once a proposal is approved, it moves to the implementation stage, which may be called the perform stage 59 or an alternative, user-defined name. The perform stage 59 is further described, below, in relation to FIG. 2.

The data elements of the idea, entered earlier in the process, are available at any stage due to the full integration of the software, as previously described in relation to the first preferred embodiment.

With specific reference to FIG. 2, a team 62 is selected—the team can be one individual, or a plurality of individual users, or even broader a plurality of team members even if one or more team members are not “users”). Next, sprint planning occurs—a sprint 64 is a temporal unit (time boxed unit pre-determined by the system or by the user or by the organization deploying the software tool, for example) that is pre-defined and during which one or more actions occur that relate to tasks or sub-tasks on the path toward the overall goal. Sprint planning includes the creation of tasks, assignment of those tasks, sending to and receiving by the team members their respective task(s), and doing the task along with a reporting by those assigned team members the progress of the task, for example.

Some initiatives will not be achieved in the time it takes to run one sprint, thus one or more time boxed events (i.e. Sprint) may be required to achieve the stated initiative.

Now, with specific reference to FIG. 1, which depicts an overview of this software tool 90 according to this second preferred embodiment of the present invention, the contemplated stages (Lead 51, Engage 53, Act 55, and Perform 57)—as generally described in FIG. 2—include similar characteristics for any one of a plurality of simultaneous or serial (or both) initiatives 60, as described in FIG. 2, for example.

During the Lead stage 51, a user must transform the idea 915 (FIG. 2) in his or her head and input that idea into the computerized system in a way that the system can then use. To assist the user to input various plan data, for example, benchmarking competitors, gathering performance metrics, surveys) (to improve some aspect of the business or other endeavor), the system provides pre-determined templates 75 that can be used to develop and input a plan 901, the output goals of which are fed into the Goal Matrix 69. The system 90 includes feature sets that are configured to enable the user to form this improvement idea in the first place. Perhaps the user is unsure of what improvement should be undertaken, thus, in the lead stage 51, a survey result 903 can be used to help identify possible problems with quality, delivery and cost and to solicit suggestions that assist with goal setting— and to obtain a survey result 903, the user may first elect to build a survey using a survey template 905. This combined mental and computerized process may yield many goals and objectives 907, or those goals and objectives may be pre-determined (based on previous iterations), for example. The unassigned goals and/or objectives are stored in the matrix in a repository 909. This initiative 60, in the lead stage 51 also includes the identification of team members, sprints, tasks, and subtasks—all as previously described, above—And, as discussed, these various data elements are communicates, as appropriate, to other users, as previously discussed.

Meanwhile, and throughout all times, and during all initiatives, sprints, and other activities, the system is able to report status and other parameters (as previously discussed, above) by the reporting feature set 950 (FIG. 2) Meanwhile, and throughout all times, and during all initiatives, sprints, tasks, subtasks, users and other activities, the system is able to send alerts to users when business rules are violated and/or thresholds exceeded.

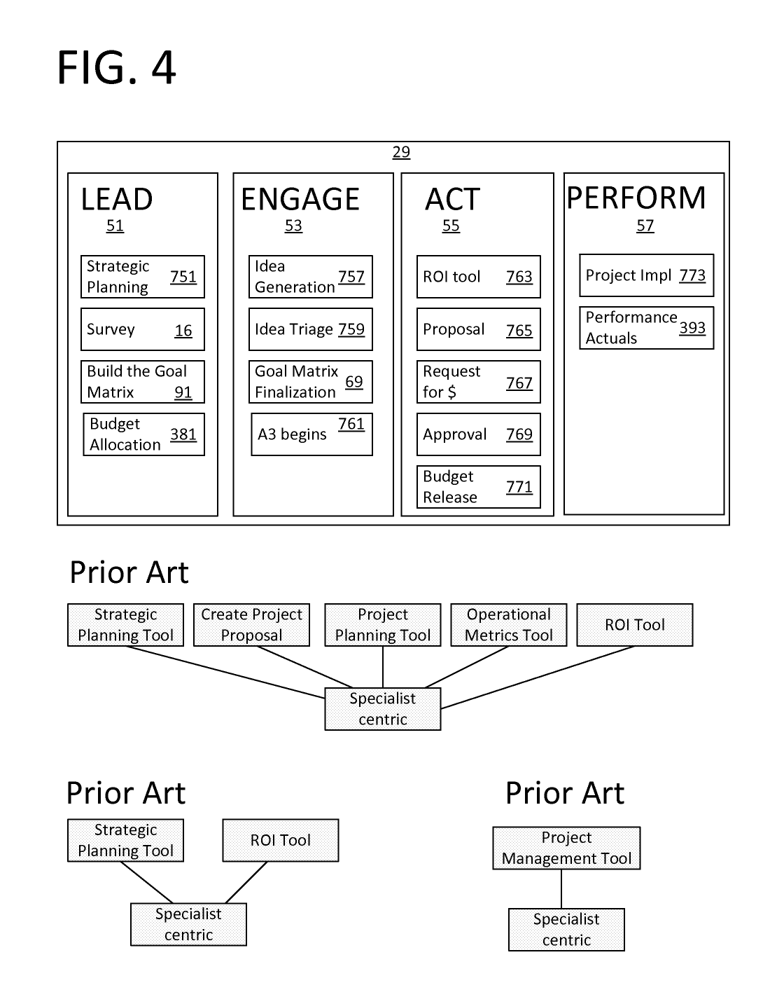

The Engage Stage 53, begins with a new initiative or a link to an existing initiative, In Engage ideas 913 are cultivated on how to execute to the plan and more specifically to goals outputted during the Lead Stage. During the Engage stage 53, a user must transform the idea in his or her head and input that idea 915 into the computerized system in a way that the system can then use. To assist the user to input various ideas to achieve the goals, the system provides pre-determined templates 75 that can be used to develop and input data elements, for example ideas. These ideas are associated and linked to goals by the system. Some of the ideas will not be germane to the goals or meet the prioritization threshold and will be stored in the repository 909. Other ideas 915 will be germane to the goals and objectives and, based on business rules 501 and weighting of goals and objectives, will be triaged 759 (FIG. 4) and prioritized and they come into play during the Act Phase 55, to be discussed below. Again, new data elements are generated here, previous data elements may be transformed and the system communicates all these activities and data elements to the users that are assigned. New data elements (i.e. tasks and subtasks) may also be generated in this stage and new relationships to users are fully communicated, stored, retrieved, and otherwise manipulated by the system 90 (FIG. 1) and transformed into the matrix 69 (FIG. 2). Specific goals and objectives germane to this initiative are fed into the goal/objective repository 917 along with the ideas generated in the Engage phase.

In the Act Stage, one or a plurality of initiatives begins by starting a new or linking to an existing initiative and by pulling triaged and prioritized ideas from the goal matrix into the Work in Progress (“WIP”) of the Act Stage. One or a plurality of Sprints linked to the initiative with team members, tasks and subtasks is started to vet the prioritized ideas.

The system 90 assesses the effectiveness of the prioritized ideas against the desired goal and objective (from the appropriate repository 917) by analyzing 919 and also determining a return on investment 921. (Again, the user has access to predetermined templates, such as a template 505. for analyzing the effectiveness of the idea against the desired goal, specific tasks or subtasks, and similarly has a template 603 to assist in structuring an appropriate ROI calculation). The system provides an alert feature to send proposals requesting funding 767 (FIG. 4) for review and approval to linked users, for example sponsors.

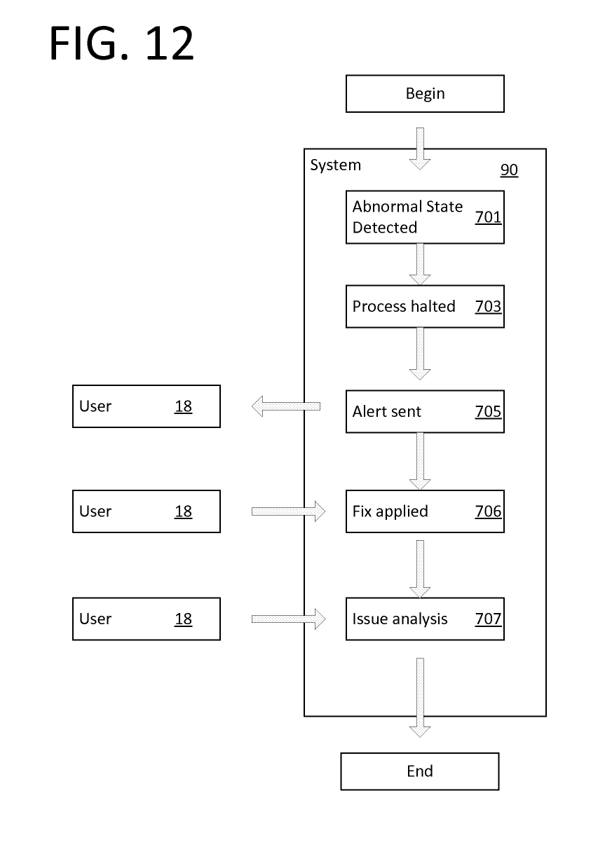

Autonomation (FIG. 12) is a software feature set that detects 701 that an abnormal situation has arisen, stops that situation from progressing (process halting or stops the process) 703, and alerts 705 user to allow human users to investigate 707 the root cause of the abnormal situation. An example of this is (a) the software detects that Work in Progress limit is exceeded, (b) this situation is stopped by automatically stopping new projects to enter WIP, (c) next the system or software tool sends an alert to Human users to allow them to fix the immediate problem. Then, (d) this allows humans to investigate to root cause. A further example of this is a) the software detects that a request to the Investment Pool exceeds the dollar limit, b) Software stops and does not allow the $ to be applied to a new project, c) Software alerts user or users of the problem so that they may fix 706 the immediate problem d) Allows humans to investigate to root cause.

The system sends an alert to the user, for example a sponsor, that a proposal requesting funding is waiting review and approval. The user reviews the completed template, ROI and any attachments. If the user approves of the proposal and associated funding request 767, the user, linked to the investment pool and within their authority level, can assign investment pool dollars to the improvement proposal 771 (FIG. 4). The system will reduce the amount of the investment pool equal to the amount assigned to the improvement proposal 212 (FIG. 1) The system has the ability to send updates of budget dollars used from the investment pool to external systems.

Finally, in the Perform stage 57, one or a plurality of initiatives begins by starting a new or linking to an existing initiative. One or a plurality of users pulls approved and funded (if necessary) projects for implementation into the WIP (work in process) of the perform stage. Sprints, team members, tasks and subtasks are assigned as in previous stages to implement the approved project.

The analysis data elements (in progress and at end of the initiative) are fed to the appropriate user. If performance at any part of the end-to-end process falls outside of a desired range, an alert mechanism triggers 927. And, final results 929 of the initiative's effectiveness is outputted from the matrix 91.

Transforming (FIG. 5) refers to the system feature that allows for receiving of one or a plurality of data element inputs by one or a plurality of users in their raw form and transforming the raw data elements 25 into distinctly different data elements 25 for use by one or more users of the system. An example of this includes raw data entered into the system by one or a plurality of users into the system for the purpose of strategic planning 67. The system transforms the raw data into a distinctly different data element such as a completed strategic plan. A further example includes transforming data elements such as goals and/or objectives, entered by the user as raw data, into a distinctly different data element, for example, a goal matrix 69. A further example includes transforming raw data entered as the data element “idea”913 into a distinctly different data element, for example an A-3 form 765. A further example includes transforming raw data elements entered as, for example, root cause analysis or proposed improvements or proposed implementation schedule into a distinctly different data element, for example, an A3. A further example includes transforming raw data entered into the systems ROI calculator 763 into a distinctly different data element, a completed ROI 921. A further example includes transforming raw data entered into the system into a distinctly different data element, for example Key Performance Indicators and/or operational metrics requesting specific inputs from the user based on where that user is in the software tool. The software tool then instantly transforms that input into new output for other uses by the system. These inputs and outputs are a form of data-elements. For example, a user may be at a stage in the software tool whereby the user should now input team members to whom tasks and subtasks will be assigned. The software tool is configured to enable the user to input these team member names and then, without activity by the user and in the background, the tool “transforms” this inputted data-elements (team member names) to a new data-element and launches (in this example) an e-mail message to each identified team member asking that team member to accept the relationship (on the user's new team). Likewise, when the user assigns a specific team member a specific task by inputting this data-element, the tool transforms this input to, again in this example, e-mail that team member and notify the team member that there is a task waiting to be accepted. Accordingly, the team member in accepting the task creates a new data-element and this is likewise “transformed” as information sent back to the user informing the user of the acceptance, for example.

Making reference now to FIG. 5, another way to understand the transforming feature of the present invention includes A3 (reference number 943). For a given initiative, an idea 915. is step-by-step broken down into tasks 66 and sub-tasks 68, the idea as such is further transformed by applying a return on investment (ROI) 921 calculation and analyzed according to certain business rules to determine feasibility. Should this idea that is a part of a particular goal and objective 917 meet the feasibility and ROI objectives, this idea is transformed into at least one, and more likely a plurality, of tasks and subtasks (66 and 68), which are assigned to a particular user (or users). And this transforming feature creates corresponding data-elements and these data-elements initiate other processes within the software tool, ultimately yielding a data-element that is delivered to a particular user so that the user may act (implement) that step of the overall initiative.

The advanced dynamic assistant feature set (FIG. 9) of the present invention refers to the system and, particularly, the software tool's ability or configuration to know where each user is within the software tool, that particular user's skill level with the software tool, and the characteristics of that user (representing that user's real-life skills, training, and abilities) and assessing what information (data-elements that are uniquely transformed in the transforming feature set) needs to accomplish tasks and subtasks related to the specific goal or initiative associated with that user. The engagement feature set further (FIG. 6) is configured to track the progress and track the status of each data-element to provide a particular user instant access to what is occurring in relation to goals and initiatives. The engagement feature set is not the same concept as the Engage Stage 53. The engage stage 53 refers more specifically to the solicitation of ideas, for example, from the users based on leadership initiatives established in the Lead Stage 51, as previously discussed above.

The user-identity feature set of the present invention refers to the software tool's configuration to know where each user is within the software tool, that particular user's skill level with the software tool, and the characteristics of that user (representing that user's real-life skills, training, and abilities), for example.

The integration feature set (FIG. 4) refers to the software tool's fully integrated end-to-end process flow inclusive to the four vertical features sets of Lead, Engage, Act and Perform. This is essential for effective strategic execution of the plan and associated goals. The software additionally has the ability and configuration to transform data-elements or groups of data-elements into useful output files for use by external software components, for example. In a more particular example, the software tool 90 configures to determine a ROI analysis 921, which is transformed into an A3 within the software, or more broadly, for a particular initiative the outputted data-element is transformed Similarly, the software tool is configured to integrate with other external software components such as e-mail servers and interfaces, web-browsers, spreadsheets, databases, and the like, for example.

This software tool consists of feature sets and is configured to comprise: A plurality of feature sets whereby each feature set, respectively, is configured to send and receive operable instructions to the computer system, store a plurality of data-elements, and send and receive any combination of the plurality of data-elements to and from any combination of the plurality of feature sets.

This software tool further comprises a user-centric interface feature set 27 (FIG. 3) configured to prioritize user-specific data-elements and configure a user's interface to present the prioritized, user-specific data-elements associated with that user.

One example of the user-centric interface feature set or aspect of the software tool is this following example:

Data is presented because there is a link between the user name and the data to be presented either by subscription, assignment, sign up or other methods.

Initiative #1 is linked to Goal “ reduce costs by 5%”
Initiative #2 is linked to Goal “ meet same day delivery”

Bob is the Project Manager of initiative #1 and #2.
Sam is the Sponsor of initiative #1.
Sally is the Sponsor of initiative #2.
Bill, Barry, Ben are team members for Initiative #1.
Bill, Barry Ben are team members for Initiative #2.

Ben has assigned a subtask to Amy

Initiative #1 has 3 team members, Bill, Barry and Ben.

Linked to this initiative:

Sprint #1 is complete.
Sprint #2 is underway

Open tasks for Sprint #2:

All tasks are “assigned” and “accepted”

Bill - complete specification - 2 days late.
Barry - get pricing from vendor - due tomorrow
Ben - get internal costs - due today
Initiative #2 has 3 team members, Alice, Amy and Andy

Linked to this initiative

Sprint #1 underway
Open tasks for Sprint #1
All tasks are “assigned” and “accepted”

Bill- complete flow chart - due today
Barry - complete survey - due in one day
Ben -get internal costs - 2 days late.
Subtask - Amy - run cost report

Given the above scenarios: the “user centric” software works like this: Sam, the Sponsor of initiative #1 has set up his subscription to the initiative to alert him if any task is late over 2 days and/or if any Sprint is late over 2 days. Sam receives an alert on his phone that there is one task late 2 days on initiative #1.

Sally, the Sponsor of initiative #2, has set up her subscription to alert her of any Sprint that is late over 3 days. So, even though there is a task late on Sprint #2,

Sally gets no alert because she did not want to be bothered with those details.

Bob, the Project Manager of Initiative #1 and #2, wants an alert of all tasks in any Sprint is late 2 days and an alert for “newly completed” tasks. So when Bob signed into the software yesterday, he received an alert that on Bill's task on initiative #1 was late. He used the software communicator to ask Bill about this task and Bill stated that he was overloaded with his task in initiative #2 and asks the PM to prioritize. Bob communicates that the Task on initiative #2 takes priority. Task #1 remains late but with an explanation.

Bill, the team member, wants to see all of his open tasks. So, when he signs into LEAP, the software recognizes Bill and presents Bill with all tasks linked to him because he has accepted these tasks.
Task: Complete specification—2 days late
Task: Complete flow chart—due today

Bill completes the flow chart (in MS Visio) and adds the attachment to the task and selects “complete”. The completed task no longer shows up when Bill logs into Leap.

Bob, the PM, receives an alert on his device that Bill's task is complete.

Bob can look at the completed task verbiage and the attachment and determine if he is satisfied with this.

Barry, a team member, wants to see all of his open tasks. So, when Barry signs in, the software recognizes Barry and presents Barry with all tasks linked to him because he has accepted the task.

Task: Get vendor pricing—due in 1 day

Task: Complete survey—due in 1 day

Ben, a team member, wants to see all of his open tasks. So when Ben signs in, the software recognizes Ben and presents Ben with all tasks linked to his user name because he has accepted the task.

Task: Get internal costs—due in 3 days

Task: Get internal costs—due in 3 days

Ben realizes that he is too stretched and he needs help. So, he recruits Amy, the reporting analyst to help him. Ben uses LEAP to assign a “subtask” to his “task” to Amy with a due date of 2 days. Amy “accepts” the subtask. Ben still owns responsibility for completing task, even if he assigns one or more subtasks.

This software tool further comprises an end-to-end process flow feature set 29 (FIG. 4) configured to create relationships between discrete data-elements and collect a plurality of data-elements based on a rule set defined by the relationships.

This software tool further comprises a transforming feature set 31 (FIG. 5) configured to manipulate related data-elements into transformed data-elements and outputting the transformed data-elements to at least one user.

This software tool further comprises an engagement feature set 33 (FIG. 6) configured to enable a plurality of users to create new data-elements and to associated any new data-element to a goal, the engagement feature set further configured to track progress of the new data-element relative to the goal.

And, this software tool further comprises a user-identity feature set 35 (FIG. 9) configured to identify the at least one user and determine what operation in the software the at least one user is interfacing and determining an experience level for the at least one user and provide on-demand assistance to the at least one user based on the experience level and the operation.

Additional components of this software tool include an integration feature set 212 (FIG. 1) configured to enable the at least one user to exchange (send and receive) a plurality of data-elements internally (within the computer system) and externally (outside the computer system) by wired or wireless communication protocols and link the plurality of data-elements to the software tool.

Another component of this software tool is a user-specific configurable feature set 214 (FIG. 8) configured to enable the user to define and re-define predetermined parameters into user-specific parameters. Accordingly, the tool includes constructs that are configured to enable any user to define goals, tasks, sub-tasks, operations, metrics, and other data-elements (collectively, “characteristics”) using predetermined parameters, or adapting a pre-determined parameter to define a new characteristic (re-define). For example, there may be various “business rules” 501. One pre-defined rule includes sending message about a task to a user. The rule includes sending a specific task to a specific user based on a heuristic determined by the user (or by another user, i.e. supervisor). One example, depicted in the following table, includes a business rule called “pulling form the backlog” and a set of predetermined characteristics associated with this rule includes 1) manual notification, 2) push notification, or 3) pull notification, for example. Other examples of pre-determined characteristics are also described below:

| | | |
|---|---|---|
| Business | Pulling from the backlog | Can set it for several settings: |
| Rules | | 1. Manual—a notification is |
| | | sent out to those users |
| | | that are overseeing the |
| | | matrix when a project is |
| | | completed. |
| | | 2. Push—an initiative is |
| | | automatically assigned and |
| | | scheduled based on saved |
| | | settings. |
| | | 3. Pull—a notification is sent |
| | | to the team leaders who |
| | | can then select to be |
| | | assigned to that initiative. |
| | The default length of a | |
| | sprint | |
| | The type of attachments | |
| | to be handled in the | |
| | system | |
| | The approval required for | Group, level, role, etc. |
| | an A3 | |
| | Post implementation | |
| | review period | |
| | Approval rules | Determine if some projects can |
| | | fast path through the approval |
| | | process |
| | | Decides whether a user can start |
| | | a project with no ideas or |
| | | initiative or approval. |
| | The OnBoarding process | Allow for controlling the options |
| | | for OnBoarding: |
| | | What email to send |
| | | What message/video to display at |
| | | the beginning |
| | | Branding |
| | | What hurdles they need to |
| | | overcome to OnBoard |
| | Planning with the big | Can turn on the suggestions/info |
| | board | from user's past projects and |
| | | from other organizations that are |
| | | using this tool |
| Dictionary | Terminology | Idea, Goal, Matrix, Initiative, |
| | | Sprint, Project, Task, Approval, |
| | | Subscription, Risk, Sponsor, Stake |
| | | Holder, Team Member, Think, |
| | | Propose, Implement, etc. |
| Template | ROI | Each organization can modify the |
| | Survey | standard ROI templates or can |
| | Plan | add their own. |
| | A3 | |
| | Sprint | |
| User | User Interface Branding | Colors, logos, etc. |
| Interface | | |
| User | Subscriptions | User selects how system will |
| Experience | | alert. A default to certain settings |
| | | based on user's role within a |
| | | project is pre-selected. |
| | User landing web pages | The landing page is automatically |
| | | configured based on the user's |
| | | roles. |
| | | User can also customize the view |

Yet another component of this software tool is an advanced dynamic assistance feature set 37 (FIG. 9) configured to provide graphical, video and text information to the at least one user when a first pre-determined condition triggers. Accordingly, a user is inputting to the system using various input techniques including selecting characteristics from pull down menus. The software tool, based on both the user identity and the current input that the user is inputting determines possible “help” topics that may arise. If a condition occurs, for example, the user takes too long to input the next piece of information, or if the user requests “help”, a dynamic help assistant may open, for example a pop up window or other method and solicits information about the users need for help and offers suggestions to the user.

At any point during any stage 50 or within any data element or the goal matrix 69 a Dynamic Assistant 37 can be requested by the user, or can be launched by the software based on pre-determined conditions. FIG. 9 provides an overview of such a Dynamic Assistant 37 as generally contemplated in this second preferred embodiment. The Dynamic Assistant can take a graphical format that presents itself to a user in an easy-to-read, easy-to-comprehend format. For example, as a user is at a particular activity in a stage, one step 3701 is highlighted in a list of a plurality of tasks—the highlighted step corresponds to the activity that the user is currently working on. A graphical display area presents itself to the user. The graphical display area consists of any combination of hints 2001, video 2003, examples 2005, and live examples 2007. And, a “Go” field 75 is configured to enable the user to input desired commands to the system. The Go field 75 includes any combination of templates, rules, wizards, pull-down menus, tick-boxes, pre-formed field entries, pre-determined data-elements, user-definable data-elements, and other similar aids, for example.

Another aspect of the present invention is a feature set configured to generate surveys as previously discussed in relation to the first preferred embodiment.

Although the invention has been particularly shown and described with reference to certain embodiments, it will be understood by those skilled in the art that various changes in form and detail may be made without departing from the spirit and scope of the invention.

We claim:

1. A computer-implemented method to accomplish organizations strategies and goals by at least on user using at least one computer system, the method comprising:
providing a multi-user software tool comprising a plurality of feature sets whereby each feature set, respectively, is configured to send and receive operable instructions to the computer system, store a plurality of data-elements, and send and receive any combination of the plurality of data-elements to and from any combination of the plurality of feature sets, the software tool further comprising
a user-centric interface feature set configured to prioritize user-specific data-elements and configure a user's interface to present the prioritized, user-specific data-elements associated with that user,
an end-to-end process flow feature set configured to create relationships between discrete data-elements and collect a plurality of data-elements based on a rule set defined by the relationships,
a transforming feature set configured to manipulate related data-elements into transformed data-elements and outputting the transformed data-elements to at least one user,
an engagement feature set configured to enable a plurality of users to create new data-elements and to associated any new data-element to a goal, the engagement feature set further configured to track progress of the new data-element relative to the goal, and
a user-identity feature set configured to identify the at least one user and determine what operation in the software the at least one user is interfacing and determining an experience level for the at least one user and provide on-demand assistance to the at least one user based on the experience level and the operation;
using the multi-user software tool to attain at least one organizational goal or strategy.

2. A computer-implemented software tool comprising:
a plurality of feature sets whereby each feature set, respectively, is configured to send and receive operable instructions to the computer system, store a plurality of data-elements, and send and receive any combination of the plurality of data-elements to and from any combination of the plurality of feature sets, the software tool further comprising
a user-centric interface feature set configured to prioritize user-specific data-elements and configure a user's interface to present the prioritized, user-specific data-elements associated with that user;
an end-to-end process flow feature set configured to create relationships between discrete data-elements and collect a plurality of data-elements based on a rule set defined by the relationships;
a transforming feature set configured to manipulate related data-elements into transformed data-elements and outputting the transformed data-elements to at least one user;
an engagement feature set configured to enable a plurality of users to create new data-elements and to associated any new data-element to a goal, the engagement feature set further configured to track progress of the new data-element relative to the goal; and
a user-identity feature set configured to identify the at least one user and determine what operation in the software the at least one user is interfacing and determining an experience level for the at least one user and provide on-demand assistance to the at least one user based on the experience level and the operation.

3. The software tool of claim 2 further comprising:
an integration feature set configured to enable the at least one user to exchange (send and receive) a plurality of data-elements internally (within the computer system) and externally (outside the computer system) by wired or wireless communication protocols and link the plurality of data-elements to the software tool.

4. The software tool of claim 2 further comprising:
a user-specific configurable feature set configured to enable the user to define and re-define predetermined parameters into user-specific parameters.

5. The software tool of claim 2 further comprising:
an advanced dynamic assistance feature set configured to provide graphical and text information to the at least one user when a first pre-determined condition triggers.

6. The software tool of claim 2 wherein the plurality of feature sets further comprises:
an autonomation feature set configured to detect an abnormal situation and further configured to enable a user to fix the situation and investigate the root cause thereof.

7. The software tool of claim 2 wherein the plurality of feature sets further comprises:
a collaboration feature set utilizes messaging as a means to an end to solve a problem.

8. The software tool of claim 7 wherein the collaboration feature set further comprises:
a tagging feature.
